(19) United States
(12) Patent Application Publication
(10) Pub. No.: US 2005/0010676 A1
(43) Pub. Date: Jan. 13, 2005

(54) Time-based transmission queue for traffic management of asynchronous transfer mode virtual circuits on a multi-threaded, multi-processor system

(76) Inventors: Muthaiah Venkatachalam, Beaverton, OR (US); Rajendra Yavatkar, Portland, OR (US)

Correspondence Address: BUCKLEY, MASCHOFF, TALWALKAR LLC, 5 ELM STREET, NEW CANAAN, CT, 06840, US

(21) Appl. No.: 10/609,707

(22) Filed: Jun. 30, 2003

(51) Int. Cl. G06F 15/16

(52) U.S. Cl. 709/232

(57) ABSTRACT

According to some embodiments, a time-based transmission queue is provided for traffic management of asynchronous transfer mode virtual circuits.

### BACKGROUND

A connection-oriented network, such as an Asynchronous Transfer Mode (ATM) network, may be used to exchange information between devices. To facilitate the exchange of information, a connection called a “virtual circuit” may be formed between the devices. Moreover, different virtual circuits may be associated with different quality of service categories. For example, one virtual circuit may exchange information at a Constant Bit Rate (CBR) while another exchanges information at an Unspecified Bit Rate (UBR).

A single device, such as an ATM switch, may need to exchange information associated with many different virtual circuits. For example, a single device might need to support thousands of virtual circuits. In this case, it may be difficult to determine when information should be exchanged with respect to various virtual circuits and/or quality of service categories. As a result, traffic management of these virtual circuits to meet the appropriate traffic characteristics and output behavior may be an important aspect of ATM switches and similar devices.

### BRIEF DESCRIPTION OF THE DRAWINGS

FIG. 1 is a block diagram of a network processor.

FIG. 2 is a block diagram of a portion of a traffic management apparatus according to some embodiments.

FIG. 3 is a flow chart of a method according to some embodiments.

FIG. 4 is a block diagram of a traffic management apparatus according to some embodiments.

FIG. 5 illustrates virtual circuit queues according to some embodiments.

FIG. 6 illustrates time-based transmission queues according to some embodiments.

FIG. 7 illustrates a hierarchical transmission availability structure according to some embodiments.

FIG. 8 is a flow chart of a method according to some embodiments.

FIG. 9 is a block diagram of a system according to some embodiments.

### DETAILED DESCRIPTION

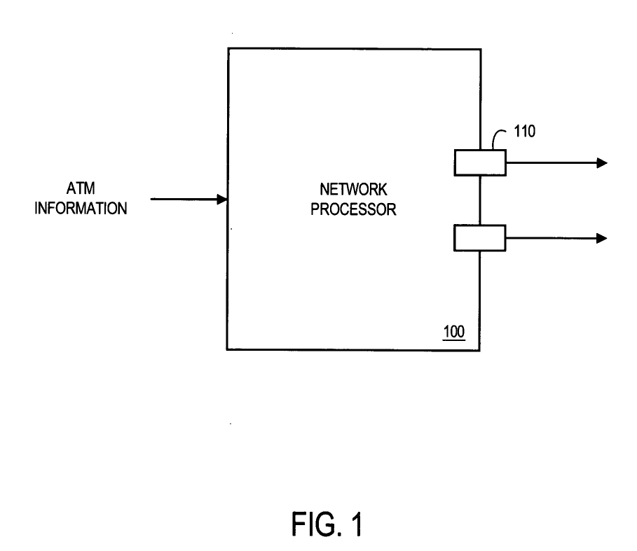

FIG. 1 is a block diagram of a network processor 100, such as an INTEL® IXP 2800 network processor. The network processor 100 may receive and/or transmit ATM information (e.g., through one or more ports 110) that is associated with a number of different virtual circuits (e.g., several thousand virtual circuits) and/or quality of service categories. For example, ATM information may be exchanged in accordance with ATM Forum Technical Committee document number AF-TM-0121.000 entitled “Traffic Management Specification Version 4.1” (March 1999). In this case, virtual circuits can be associated with various quality of service categories, including: CBR, Variable Bit Rate-real time (VBR-rt), Variable Bit Rate-non real-time (VBR-nrt), UBR, and Guaranteed Frame Rate (GFR). Note that a network processor may use traffic management algorithms to honor the quality of service agreements for thousands of virtual circuits.

Traffic Management Apparatus

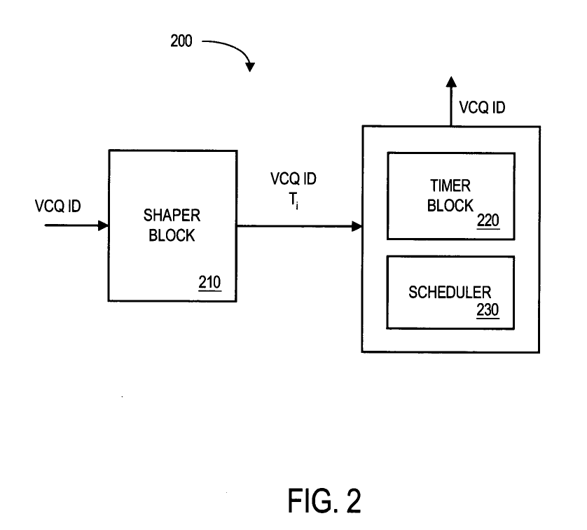

FIG. 2 is a block diagram of a portion of a traffic management apparatus 200 that may be used to facilitate an exchange of ATM information according to some embodiments. For example, a network processor might determine that a fixed-size packet of information will be transmitted, such as an ATM cell having 5 bytes of header information along with 48 bytes of data. As another example, a packet might be a frame that includes a number of different ATM cells.

The apparatus 200 may facilitate the transmission of ATM cells stored in virtual circuit “queues” (e.g., a storage structures in memory, each structure having a number of positions associated with a virtual circuit connection). The virtual circuit queues store ATM cells that need to eventually be transmitted (e.g., when a network processor has received ATM information at a rate faster than it could be transmitted through one or more ports), and a shaper block 210 determines when a particular ATM cell in those queues will be transmitted. For example, the shaper block 210 may determine that a first ATM cell in a CBR virtual circuit queue will be transmitted before a second ATM cell in a UBR virtual circuit queue (even though the first ATM cell was received after the second ATM cell).

According to some embodiments, the shaper block 210 receives a virtual circuit queue identifier (VCQ ID) that indicates a virtual circuit associated with an ATM cell that needs to be transmitted (e.g., from a previous block). The shaper block 210 calculates an intended transmission time (Ti) for every cell that is incoming on that virtual circuit (e.g., based on the circuit's quality of service category).

According to some embodiments, the shaper block 210 then provides the VCQ ID and Ti to a timer block 220 that stores the VCQ ID in a time-based transmission queue in accordance with Ti. The time-based transmission queue may, for example, have a number of positions with each position representing a period of time during which an ATM cell may be transmitted (e.g., a time “slot”). In this case, the timer block 220 can store the VCQ ID in an appropriate position based on Ti and the period of time associated with that position.

A scheduler 230 may then use the current time (e.g., as indicated by a clock value) to retrieve a VCQ ID from the appropriate position in the time-based transmission queue. The scheduler 230 may provide the retrieved VCQ ID to, for example, a queue manager that will retrieve an ATM cell from that virtual circuit queue (“dequeuing” the ATM cell) and arrange for it to be transmitted on the wire.

Traffic Management Method

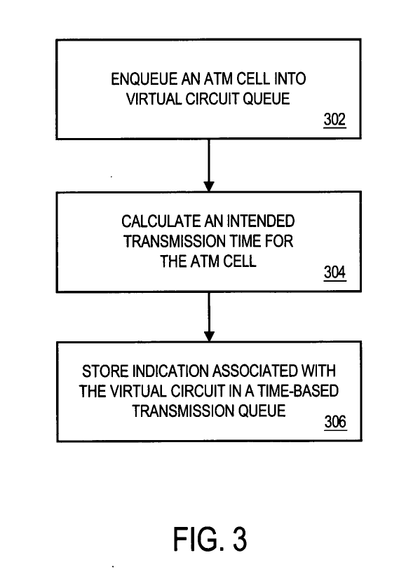

FIG. 3 is a flow chart of a method according to some embodiments. The flow charts described herein do not necessarily imply a fixed order to the actions, and embodiments may be performed in any order that is practicable. The method of FIG. 3 may be associated with, for example, the portion of a traffic management apparatus 200 illustrated in FIG. 2. Note that any of the methods described herein may be performed by hardware, software (including microcode), or a combination of hardware and software. For example, a storage medium may store thereon instructions that when executed by a machine result in performance according to any of the embodiments described herein.

At 302, an ATM cell is stored into one of a plurality of virtual circuit queues (“enqueuing” the cell). At 304, an intended transmission time (e.g., Ti) is calculated for the virtual circuit queue. An indication associated with the virtual circuit queue (e.g., VCQ ID) is then stored in a time-based transmission queue in accordance with the intended transmission time at 306.

### EXAMPLE

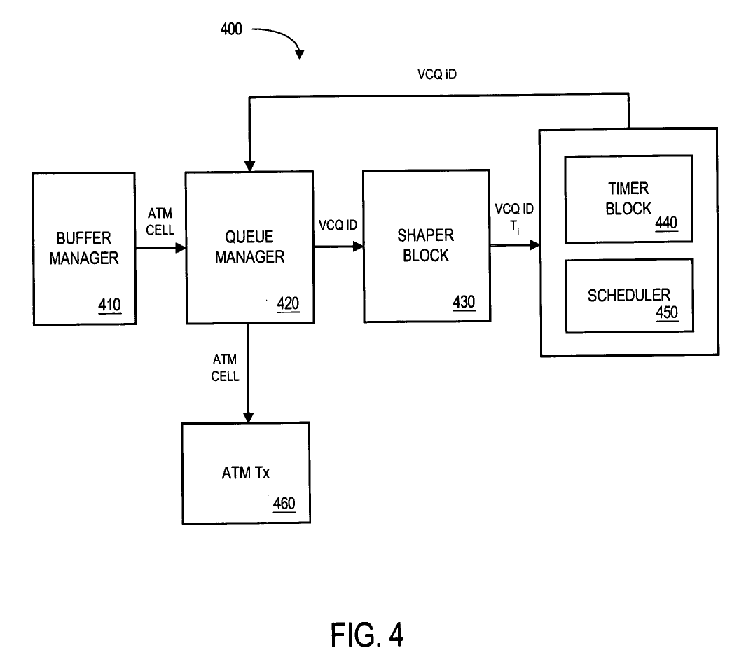

FIG. 4 is a block diagram of a traffic management apparatus 400 according to some embodiments. The apparatus 400 includes a buffer manager 410 that may provide an ATM cell to a queue manager 420.

The queue manager 420 may enqueue the ATM cell into an appropriate virtual circuit queue and provide an identifier associated with that virtual circuit queue (VCQ ID) to a shaper block 430, which in turn calculates an intended transmission time (Ti) for that virtual circuit queue.

The shaper block 430 may provide the VCQ ID and Ti to a timer block 440 that stores the VCQ ID in a time-based transmission queue in accordance with Ti. A scheduler 230 may then use the current time to retrieve the VCQ ID from the time-based transmission queue and provide that VCQ ID to the queue manager 420. The queue manager 420 may dequeue the ATM cell and provide it to an ATM transmission block (Tx) 660 to be transmitted. The elements of the apparatus 400 according to some embodiments will now be described.

Buffer Manager

The buffer manager 410 may receive ATM information (e.g., from a switch fabric). For example, the buffer manager 410 decide whether or not a network processor will accept ATM information.

In accordance with ATM Adaptation Layer 1 (AAL1), the buffer manager 410 may provide ATM cells to the queue manager 420 on a cell-by-cell basis. According to other embodiments, the buffer manager 410 provides a frame that has multiple ATM cells embedded in it, to the queue manager 420 (e.g., in accordance with AAL5).

Queue Manager

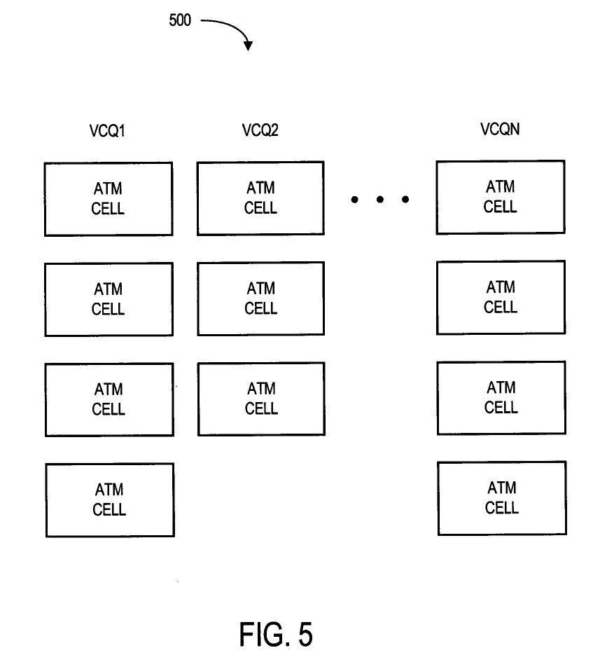

The queue manager 420 may enqueue a newly received ATM cell into an appropriate virtual circuit queue. FIG. 5 illustrates N virtual circuit queues 500 according to some embodiments. Each virtual circuit queue 500 may be, for example, a storage structure in memory having a number of positions that can be used to store ATM cells. In this case, information received from the buffer manager 410 can be used to determine which virtual circuit queue (e.g., VCQ1 through VCQN) should store a newly received ATM cell. When a frame including a number of ATM cells is received from the buffer manager 410, the queue manager 420 may enqueue the entire frame into the appropriate virtual circuit queue. When the queue manager 420 enqueues an ATM cell, it transmits the VCQ ID to the shaper block 430.

When the queue manager 420 receives a VCQ ID (e.g., from the scheduler 450), it dequeues an ATM cell from the appropriate virtual circuit queue and arranges for that ATM cell to be transmitted (e.g., by sending the ATM cell to the ATM Tx 460). Note that the queue manager 420 may dequeue ATM cells in First-In, First-Out (FIFO) order for a particular virtual circuit queue (and, as a result, ATM cells will be transmitted in the same order they were received).

Shaper Block

The shaper block 430 receives the VCQ ID from the queue manager 420 and calculates an intended transmission time (Ti) for that virtual circuit queue. For example, the shaper block 430 may retrieve a traffic descriptor associated with the that virtual circuit from external Static Random Access Memory (SRAM) or from local memory. The traffic descriptor might include a number of parameters, such as: a Peak Cell Rate (PCR), a Sustained Cell Rate (SCR), a Cell Delay Variation Tolerance (CDVT), a Burst Tolerance (BT), and a Theoretical Arrival Time (TAT). Moreover, the traffic descriptor may indicate a quality of service category associated with that virtual circuit.

Based on the traffic descriptor, the shaper block 430 may apply an algorithm to calculate an intended transmission time (Ti). For example, the algorithm may be compatible and/or compliant with Generic Cell Rate Algorithm (GCRA) techniques that define conformance with respect to the traffic contract of a connection.

According to some embodiments, the shaper block 430 first calculates an earliest departure time (t1) and a latest departure time (t2) that would be appropriate for a newly received ATM cell. For example, the shaper block 430 might calculate t1 as follows:

```
      GCRA(T,τ) on the arrival of a new cell:
      Working variables:
            t = actual cell arrival time
            TAT = theoretical cell arrival time
            t₁ = earliest departure time
      If (t > TAT − τ)
            t₁ = t;
      Else /*(t < TAT − τ)*/
            t₁ = TAT;
GCRA(T,τ) on the departure of a cell:
      Working variables:
            t_{d} = actual cell departure time
            TAT = theoretical cell arrival time
      If (t_{d} > TAT)
            TAT = t_{d} + T;
      Else /*(t_{d} <= TAT)*/
            TAT = TAT + T;
```

where t represents the actual ATM cell arrival time and TAT represents a theoretical cell arrival time. In some traffic classes (e.g., VBR), the shaper may have to calculate the GCRA time t1 twice based on two different traffic parameters for the same virtual circuit and take the maximum of the two obtained values.

Note that for non-real time traffic without delay constraints, a Cell Transfer Delay (CTD) may be assumed. In this case, t2 might be calculated as t1+Maximum CTD.

From the earliest and latest departure times (t1, t2), an intended departure time Ti may be heuristically computed as follows:
Ti=(t1+t2)/2, if the maximum CTD is less than T/2. If the maximum CTD is not less than T/2, then Ti=t1+T/2.
Such an approach may effectively meet delay constraints for CBR and VBR-rt traffic. When the calculation is finished, the VCQ ID and Ti may be communicated to the timer block 440. According to some embodiments, the apparatus 400 is implemented using multiple Reduced Instruction Set Computer (RISC) devices (e.g., microengines). In this case, the VCQ ID and Ti may be communicated using registers coupled to multiple devices (e.g., to reduce communication latency).

Timer Block and Scheduler

The timer block 440 and scheduler 450 may keep track of the departure times and schedule ATM cell transmissions in the order of the departure times. In particular, according to some embodiments, when the timer block 440 receives the VCQ ID and Ti (from the shaper block 430) it stores the VCQ ID in a time-based transmission queue based on Ti.

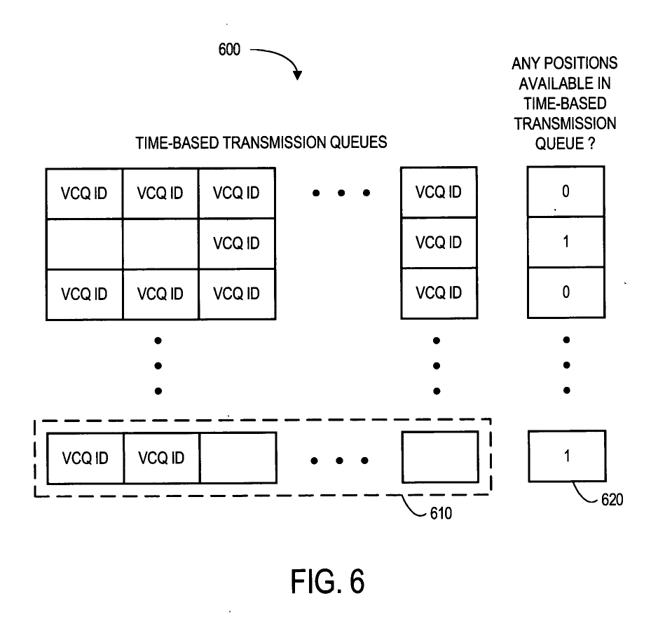

FIG. 6 illustrates time-based transmission queues 600 according to some embodiments. The time-based transmission queues 600 may, for example, be a fixed-sized structure stored in SRAM. Each time-based transmission queue 610 includes a number of positions, and each position represents a period of time during which an ATM cell could be transmitted (e.g., a time “slot”). Note that different time-based transmission queues 610 may be associated with different periods of time (and that an entire set of time-based transmission queues 600 may represent a relatively long period of time). Each position may store a VCQ ID representing a virtual circuit queue from which an ATM cell should be dequeued and transmitted during that period of time.

When the timer block 440 receives the VCQ ID and Ti, it uses Ti to select a position in one of the time-based transmission queues 610. For example, the earliest available slot after the intended transmission time might be selected. When a position is selected, the timer block 440 stores the VCQ ID into that position.

The scheduler 450 may then simply use a clock value associated with the current time to increment a pointer through the queues 600. The VCQ ID stored in the location currently being pointed to may therefore represent the virtual circuit queue from which the next ATM cell should be dequeued. The scheduler 450 can then transmit the VCQ ID to the queue manager 420 (which may dequeue an ATM cell from that virtual circuit queue and arrange for it to be transmitted).

As time passes, one time-based transmission queue 610 is emptied as ATM cells are transmitted and the pointer is advanced to the next time-based transmission queue 610. Note that the clock value may eventually wrap around (e.g., and the time-based transmission queue 610 may be re-used in the future).

According to some embodiments, information about the content of a time-based transmission queue 610 may also be stored. For example, an indication 620 as to whether or not all of the positions in the time-based transmission queue 610 are currently occupied might be stored in local memory (in FIG. 6, a “0” indicates that no positions are available and a “1” indicates that at least one position is available). Such an approach may aggregate and compress the information and improve performance (e.g., by reducing the need to access external memory). According to some embodiments, an indication of the length of each time-based transmission queue 610 is also stored in local memory. Moreover, the amount of aggregation may be programmable according to some embodiments (e.g., and may be established in accordance with a desired data rate).

The wrap-around interval, or Time Horizon (TH), associated with the time-based transmission queues 600 may be set to a targeted line rate for the apparatus divided by the slowest VC rate. Moreover, the total number of time-based transmission queues 600 may be based on TH divided by the chosen amount of aggregation in each time-based transmission queue 610.

If the apparatus has multiple ports, each port may be associated with separate time-based transmission queues 610. Whenever flow control is asserted for a particular port, ATM cells may not be transmitted from that port. Moreover, the scheduling among various ports could be based on a pre-computed schedule (e.g., so that the traffic on a port will not exceed the port's allocated bandwidth).

According to some embodiments, the scheduler 450 also handles UBR virtual circuit queues. Note that shaper block 430 and timer block 440 operations might only be performed for certain quality of service categories (e.g., CBR and VBR). When there is no ATM cell to schedule from those categories, the system might select an ATM cell from an UBR virtual circuit queue.

Hierarchical Transmission Availability Structure

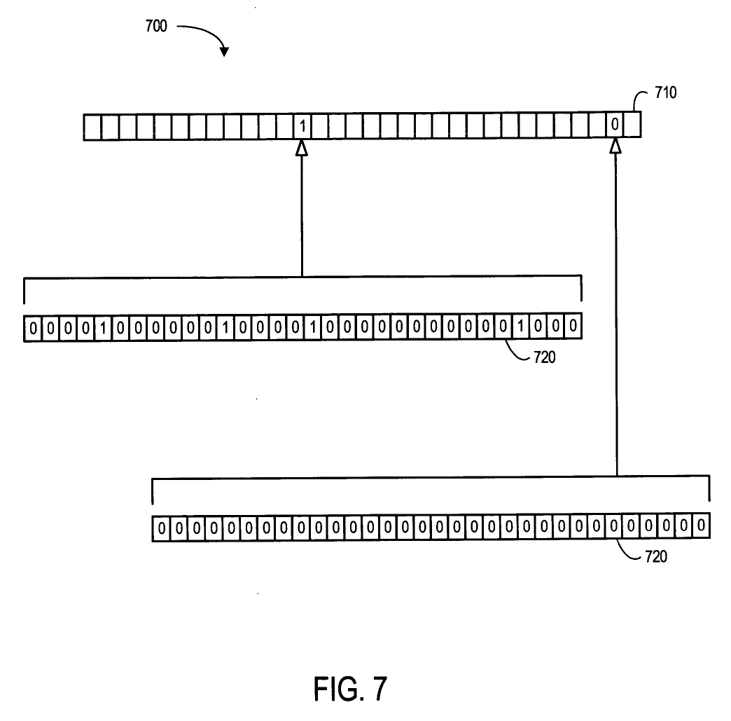

When the timer block 440 receives the VCQ ID and Ti, it uses Ti to select a position in one of the time-based transmission queues 610. Note, however, that an available position must be selected (e.g., there cannot already be a VCQ ID stored in the selected position). To facilitate the selection of an available position, the timer block 440 may use a hierarchical transmission availability structure 700 such as the one illustrated in FIG. 7.

The structure 700 may be stored in local memory and may include a 32-bit root word 710, with each bit in the root word 710 corresponding to a 32-bit leaf word 720. When every bit in a leaf word 720 is “0” (indicating that no positions are available in corresponding time-based transmission queues), the corresponding bit in the root word 710 is set to “0.” If at least one bit in a leaf word 720 is “1” (indicating that at least one position is available in corresponding time-based transmission queues), the corresponding bit in the root word 710 is set to “1.”

Such an approach may provide a fast and efficient search for an available time slot without needing to access external memory. For example, when the timer block 440 receives Ti from the shaper block 430, an empty slot may be found using a Find First Bit set instruction on the root word 710 (e.g., a single instruction that finds the first occurrence of a non-zero bit in a 32-bit word). When the timer block 440 finds the first non-zero bit, the position of the bit may be used to select a time-based transmission queue and/or position within the queue. Note that the structure 700 may be updated (i) when a VCQ ID is stored in a time-based transmission queue (e.g., to reflect that the position is no longer available) and/or (ii) when an ATM cell is dequeued and transmitted (e.g., to reflect that the position is now available). This methodology may improve performance by avoiding the need to access external memory, such as SRAM, in order to search for an available time slot for the ATM cell with respect to a hierarchical transmission availability structure.

When ATM cells can be transmitted through multiple ports, each port might have its own time-based transmission queues and/or corresponding hierarchical transmission availability structure 700. Moreover, the scheduler 450 may use a static algorithm so that no port will have its allocated bandwidth exceeded. When a port is chosen, priority scheduling may be applied between the time-based transmission queues and the UBR virtual circuit queues for that port. When there are multiple UBR virtual circuit queues, one may be selected using a weighted round robin algorithm.

Method

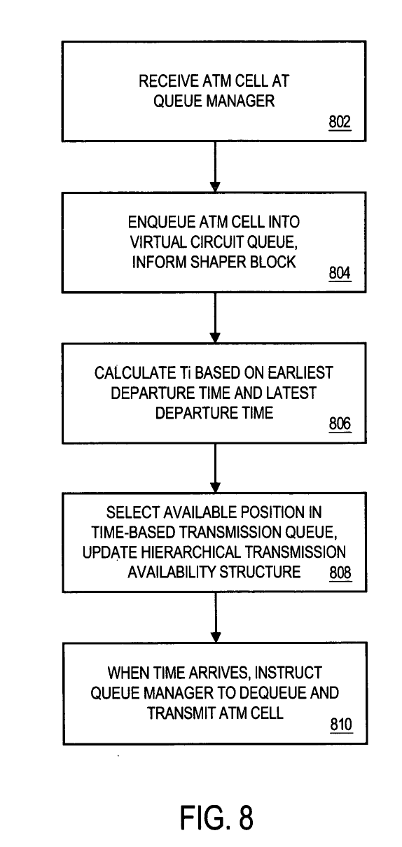

FIG. 8 is a flow chart of a method according to some embodiments. At 802, an ATM cell is received. For example, the queue manager 420 might receive an ATM cell (e.g., by itself or as part of a frame of ATM cells).

At 804, the ATM cell is enqueued into a virtual circuit queue. For example the queue manager 420 might store the ATM cell (or frame of ATM cells) in an appropriate virtual circuit queue and transmit an identifier associated with that queue to the shaper block 430.

An intended transmission time (Ti) is calculated based on an earliest departure time and a latest departure time at 806. For example the shaper block 430 may calculate Ti based on a quality of service category associated with the virtual circuit queue.

At 808, an available position in a time-based transmission queue is selected in accordance with Ti. For example, the timer block 440 may select an available position using the hierarchical transmission availability structure 700. The timer block 440 may then store the VCQ ID into that position (and the hierarchical transmission availability structure 700 may be updated to reflect that the position is no longer available).

At 810, when the time arrives (e.g., when the current time equals the time associated with the position selected in the time-based transmission queue) the queue manager 420 is instructed to dequeue and transmit the ATM cell. For example, the scheduler 450 may increment a pointer through the time-based transmission queues. The VCQ ID stored in the position currently referenced by the pointer can then be read and transmitted to the queue manager 420. When the queue manager 420 receives the VCQ ID, it retrieves an ATM cell from that virtual circuit queue and provides it to the ATM Tx 460 to be transmitted.

Embodiments described herein may be scalable with respect to (i) the number of virtual circuits that a device can support, (ii) the rate at which ATM information is exchanged (e.g., Optical Carrier level 48 line rates), and/or (iii) the rate of the individual virtual circuits. For example, the use of bit vector tables in SRAM to indicate the availability of data in the VCQs might be avoided (e.g., and such bit vector tables might have enlarged in size and degrade performance as the number of VCQs increased, due to several memory lookups per cell in order to find a position in the time based transmission queues).

In addition, the aggregation of time slots into time queues may improve the performance of both the scheduler and time, by compacting the hierarchical availability structure so that the structure may be stored in local memory (avoiding the need to access external memory to locate an available slot). Further, according to some embodiments, cell re-ordering on a virtual circuit may be avoided, multiple ports can be supported (while ensuring that ports do not exceed the allocated bandwidth), and an implementation may be fully compliant with ATM Traffic Management Specification Version 4.1. Also note that an implementation may use a modular design such that blocks may be re-used in other applications.

Moreover, embodiments may be implemented using a distributed, multi-processor system (e.g., the shaper 430 and timer block 440 might be implemented on different microengines or the shaper 430, timer 440 and scheduler 440 may be implemented on multiple threads of the same microengine), and communication latencies may be reduced by means of efficient message passing using next neighbor rings in the network processor.

System

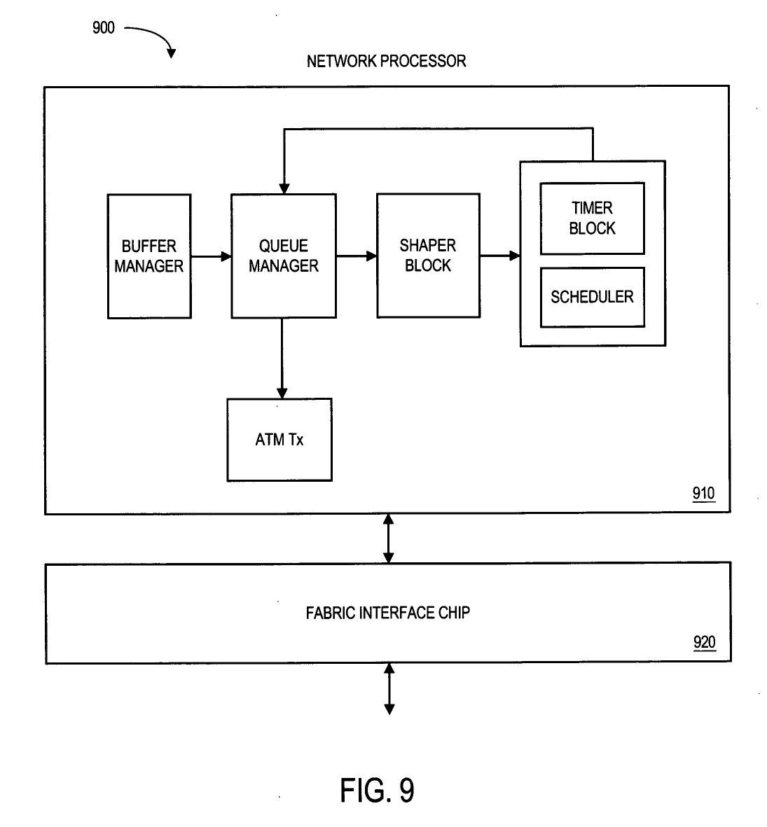

FIG. 9 is a block diagram of a system 900 according to some embodiments. The system 900 may be associated with, for example, an ATM switch.

The system 900 includes a network processor 910 according to any of the embodiments described herein. For example, the network processor 910 might have a shaper block to calculate an intended transmission time associated with an ATM cell that is enqueued into one of a plurality of virtual circuit queues. The network processor 910 may further have a timer block to store an indication associated with that virtual circuit in a time-based transmission queue in accordance with the intended transmission time.

The network processor 900 is coupled to a fabric interface device 920 adapted to communicate through a switch fabric. For example, the fabric interface device 920 might arrange for ATM information to be exchanged with another device.

The several embodiments described herein are solely for the purpose of illustration. Persons skilled in the art will recognize from this description other embodiments may be practiced with modifications and alterations limited only by the claims.

1. A method, comprising:
enqueuing an Asynchronous Transfer Mode (ATM) cell into one of a plurality of virtual circuit queues;
calculating an intended transmission time associated with the ATM cell; and
storing an indication associated with the virtual circuit queue in a time-based transmission queue in accordance with the intended transmission time.

2. The method of claim 1, further comprising:
searching for a position in the time-based transmission queue in accordance with the intended transmission time.

3. The method of claim 1, wherein the time-based transmission queue comprises a plurality of positions, each position being associated with a time period.

4. The method of claim 1, wherein said storing comprises:
determining an available position in the time-based transmission queue.

5. The method of claim 4, wherein a plurality of time-based transmission queues store information associated with a plurality of time periods.

6. The method of claim 5, wherein said determining is associated with a hierarchical transmission availability structure.

7. The method of claim 6, wherein (i) the hierarchical transmission availability structure is compressed by aggregating a plurality of transmission time slots into a single position in the, (ii) the compressed structure is stored in local memory, and (iii) an empty slot is located without accessing external memory.

8. The method of claim 6, wherein a first set of time-based transmission queues is associated with a first transmission port and a second set of time-based transmission queues is associated with a second transmission port.

9. The method of claim 1, further comprising:
dequeuing the ATM cell from the appropriate virtual circuit queue in accordance with the current time and the indication stored in the time-based transmission queue.

10. The method of claim 9, further comprising:
transmitting the ATM cell.

11. The method of claim 1, further comprising:
receiving a frame including the ATM cell.

12. The method of claim 11, wherein enqueuing the ATM cell comprises enqueuing the received frame into the virtual circuit queue.

13. The method of claim 1, wherein said calculating is associated with an ATM traffic management process and a quality of service category.

14. The method of claim 13, wherein the quality of service category is associated with at least one of: (i) a constant bit rate requirement, (ii) a variable bit rate requirement, (iii) a real time requirement, (iv) a non-real time requirement, (v) an unspecified bit rate requirement, and (vi) a guaranteed frame rate requirement.

15. An apparatus, comprising:
a storage medium having stored thereon instructions that when executed by a machine result in the following:
enqueuing an Asynchronous Transfer Mode (ATM) cell into one of a plurality of virtual circuit queues,
calculating an intended transmission time associated with the ATM cell, and
storing an indication associated with the virtual circuit queue in a time-based transmission queue in accordance with the intended transmission time.

16. The apparatus of claim 15, wherein the time-based transmission queue comprises a plurality of positions, each position being associated with a time period.

17. The apparatus of claim 16, wherein said storing comprises:
determining an available position in the time-based transmission queue.

18. The apparatus of claim 17, wherein a plurality of time-based transmission queues store information associated with a plurality of time periods.

19. The apparatus of claim 18, wherein said determining is associated with a hierarchical transmission availability structure.

20. The apparatus of claim 18, further comprising:
searching for the available position in the time-based transmission queue in accordance with the intended transmission time, wherein the searching may be performed without accessing external memory.

21. An apparatus, comprising:
a shaper block to calculate an intended transmission time associated with an Asynchronous Transfer Mode (ATM) cell enqueued into one of a plurality of virtual circuit queues; and
a timer block to store an indication associated with the virtual circuit queue in a time-based transmission queue in accordance with the intended transmission time.

22. The apparatus of claim 21, further comprising:
a hierarchical transmission availability structure, wherein the timer block is further to store the indication in the time-based transmission queue based on information in the hierarchical transmission availability structure.

23. The apparatus of claim 21, further comprising:
a scheduler to select the virtual circuit queue in accordance with the current time and the indication stored in the time-based transmission queue.

24. The apparatus of claim 23, further comprising:
a queue manager to (i) enqueue the ATM cell into the virtual circuit queue and (ii) dequeue the ATM cell from the virtual circuit queue based on information received from the scheduler.

25. The apparatus of claim 24, further comprising:
a buffer manager to provide the ATM cell to the queue manager.

26. The apparatus of claim 21, wherein the timer block is associated with at least one of: (i) a network processor, (ii) a microengine, and (iii) a distributed processing system.

27. A system, comprising:
a network processor, including:
a shaper block to calculate an intended transmission time associated with an Asynchronous Transfer Mode (ATM) cell enqueued into one of a plurality of virtual circuit queues, and
a timer block to store an indication associated with the virtual circuit queue in a time-based transmission queue in accordance with the intended transmission time; and
a fabric interface device coupled to the network processor.

28. The system of claim 27, wherein several time slots in the time-based transmission queue are aggregated to facilitate a determination of an available position via a hierarchical transmission availability structure.

29. The system of claim 27, wherein the network processor further includes:
a hierarchical transmission availability structure, wherein the timer block is further to store the indication in the time-based transmission queue based on information in the hierarchical transmission availability structure,
a scheduler to select the virtual circuit queue in accordance with the current time and the indication stored in the time-based transmission queue,
a queue manager to (i) enqueue the ATM cell into the virtual circuit queue and (ii) dequeue the ATM cell from the ATM virtual circuit queue based on information received from the scheduler, and
a buffer manager to provide the ATM cell to the queue manager.

30. The system of claim 27, wherein the shaper block, scheduler, timer block, queue manager, and buffer manager are scalable with respect to: (i) the number of virtual circuits, (ii) the rate at which ATM information is exchanged, and (iii) the rate of an individual virtual circuit.

31. The system of claim 27, wherein the shaper block, scheduler, timer block, queue manager, and buffer manager are associated with at least one of: (i) multiple microengines and (ii) multiple threads of a microengine.

32. The system of claim 27, wherein the shaper block, scheduler, timer block, queue manager, and buffer manager do not re-order ATM cells for a particular virtual circuit.

33. The system of claim 27, wherein the shaper block, scheduler, timer block, queue manager, and buffer manager reduce communication latencies by means of efficient message passing using next neighbor rings in the network processor.

34. The system of claim 27, wherein the shaper block, scheduler, timer block, queue manager, and buffer manager are implemented in a distributed, multi-threaded, multi-processor system.

35. The system of claim 34, wherein data consistency is maintained because packets are not re-ordered.

36. The system of claim 27, wherein the shaper block, scheduler, timer block, queue manager, and buffer manager are implemented in a modular way such that they may be re-used in multiple network processor applications.
